(19) United States
(12) Patent Application Publication
(10) Pub. No.: US 2025/0291178 A1
(43) Pub. Date: Sep. 18, 2025

(54) EYE TRACKING DEVICE, DATA GLASSES, AND EYE TRACKING METHOD

(71) Applicant: Robert Bosch GmbH, Stuttgart (DE)

(72) Inventors: Johannes Meyer, Haseluenne (DE); Johannes Fischer, PLIEZHAUSEN (DE); Thomas Alexander Schlebusch, Renningen (DE); Tobias Wilm, Heimsheim (DE)

(21) Appl. No.: 18/860,155

(22) PCT Filed: Jul. 13, 2023
(86) PCT No.: PCT/EP2023/069436

§ 371 Date: Oct. 25, 2024

(30) Foreign Application Priority Data
Sep. 28, 2022 (DE) 10 2022 210 271.1

(51) Int. Cl. G02B 27/00; G02B 27/01; G02B 27/10; G06F 3/01

(52) U.S. Cl. CPC G02B 27/0093; G02B 27/0172; G02B 27/1093; G06F 3/013; G02B 2027/0174; G02B 2027/0178

(57) ABSTRACT

An eye tracking device for detecting and/or tracking a pupil position in a pair of data glasses. The device includes a virtual retinal scan display having a laser projector configured to emit a laser beam bundle which includes a visible laser signal and a infrared laser signal, and which contains at least one image to be displayed, and having at least one optical system including at least one replicating optical element configured to reproduce the image to be displayed, for outputting into exit pupils of the optical system. The exit pupils are spaced apart from one another at least in a pupil plane of the virtual retinal scan display. The optical system includes a wavelength-selective optical element configured to manipulate only the infrared laser signal of the laser beam bundle and to allow the visible laser signal of the laser beam bundle to pass through at least substantially unchanged.

### BACKGROUND INFORMATION

An eye tracking device for detecting and/or tracking a pupil position, comprising at least one virtual retinal scan display having at least one laser projector configured at least to emit a laser beam bundle which comprises at least one visible laser signal, in particular RGB laser signal, and at least one infrared laser signal and which projects at least one (RGB) image to be displayed, and having at least one optical system comprising at least one replicating optical element configured at least to reproduce the (RGB) image to be displayed, for outputting into a plurality of exit pupils (eyeboxes) of the optical system, said exit pupils being spaced apart from one another at least in a pupil plane of the virtual retinal scan display is already available.

### SUMMARY

The present invention proceeds from an eye tracking device for detecting and/or tracking a pupil position, in particular in a pair of data glasses, comprising at least one virtual retinal scan display having at least one laser projector configured at least to emit a laser beam bundle which comprises at least one visible laser signal, in particular RGB laser signal, and at least one infrared laser signal and which projects at least one (RGB) image to be displayed, and having at least one optical system comprising at least one replicating optical element (of a replication optics) configured at least to reproduce the (RGB) image to be displayed, for outputting into a plurality of exit pupils (eyeboxes) of the optical system, said exit pupils being spaced apart from one another at least in a pupil plane of the virtual retinal scan display.

The optical system includes a wavelength-selective optical element configured to manipulate, in particular focus, defocus or distort, only the infrared laser signal of the laser beam bundle and to allow the visible laser signal, in particular the RGB laser signal, of the laser beam bundle to pass through at least substantially unchanged. As a result, an eye-tracking function can advantageously be integrated into the laser projector of the virtual retinal scan display. Advantageously, a visible image can be generated and pupil tracking can be carried out simultaneously by means of a single laser projector. This can advantageously reduce costs and required installation space.

A pair of “data glasses” is in particular to be understood as a wearable (head-mounted display) by means of which information can be added to the visual field of a user. Data glasses preferably make augmented reality and/or mixed reality applications possible. Data glasses are also commonly referred to as smart classes. In particular, the pair of data glasses comprises a conventional virtual retinal scan display (also known as a light field display). The virtual retinal scan display is in particular configured to scan image content sequentially by deflecting at least one visible laser beam from at least one time-modulated light source, such as one or more (RGB) laser diodes of a laser projector, and to image it directly onto the retina of the user eye by means of optical elements. The image source is in particular designed as an electronic image source, for example as a graphics output, in particular an (integrated) graphics card, a computer or processor, or the like. The (RGB) images to be displayed are in particular formed as color image data, e.g., RGB image data. In particular, the (RGB) images to be displayed may be formed as still or moving images, e.g., videos. In particular, the laser projector is provided to generate the (RGB) images to be displayed and to output them via a visible (RGB) laser beam. In particular, the laser projector comprises RGB laser diodes, which generate the visible laser beam/signal. In particular, the laser projector comprises an infrared laser diode, which generates the infrared laser beam/signal. Preferably, the visible laser signal and the infrared laser signal are combined to form the common laser beam bundle. The infrared laser diode can be integrated in laser diode system comprising the RGB laser diodes, wherein the infrared laser diode is preferably arranged at the first position, or the infrared laser beam/signal can be coupled via optical elements into the visible laser beam/signal generated by a separate laser diode system. Advantageously, if the infrared laser signal is generated via a separate infrared laser diode arranged downstream of an RGB laser module and is subsequently combined via a beam combiner with the visible laser signal to form the laser beam bundle, further optical components which may be required for the visible light (such as attenuation filters, further beam combiners for incorporating reference diodes for conduction monitoring of the RGB laser module, beam correction lenses, polarization optics, etc.) can be bypassed by the infrared laser signal. The laser projector is preferably integrated in a temple of the data glasses.

The term “exit pupil” (Ramsden circle) is in particular understood to mean an image-side image of a (virtual) aperture diaphragm of those optical components of the optical system that generate the reproduction of the (RGB) image. In particular, when the optical system is used as intended, at least one of the exit pupils of the optical system overlaps with an entry pupil of the user eye. In particular, the (RGB) image arranged preferably in a (virtual) entry pupil of the optical components of the optical system is imaged in the exit pupil. In particular, the exit pupil of the optical system forms at least part of an eyebox. In particular, a diameter of the exit pupil is less than an average diameter, preferably less than a minimum diameter, of the entry pupil of the user eye. In this case, the term “eyebox” is understood to mean a spatial area within which all light beams of the scanning projection can pass through the entry pupil of the user eye. The pupil plane of the virtual retinal scan display is preferably formed by an exit pupil plane in which the focal points of the reproduced images lie. Preferably, in normal operation, a pupil of the user of the virtual retinal scan display is arranged in the pupil plane so that the overlap of the eyeboxes with the pupil of the user can occur. The exit pupil plane may at least substantially be parallel to a lens of the data glasses. The replicating optical element (the replication optics) may preferably be designed as an achromatic segment lens. Alternatively, the replicating optical element could also be designed as a prism, DMD (digital micromirror device) micromirror array, an optical phased array, an LCoS (liquid crystal on silicone), a DLP (digital light processing) element, a liquid lens, or a controllable phase plate. The visible laser signal being able to pass, “substantially unchanged,” through the wavelength-selective optical element is in particular understood to mean that the visible laser signal has a deviation between input signal and output signal of less than 5°, preferably less than 3°, preferably less than 1°, and particularly preferably less than 0.2°, after passing through the wavelength-selective optical element. In particular, all laser signals of the laser beam bundle pass through the same optical elements on the way from the laser projector to the eye of the user and on the way back from the eye of the user to the laser projector. In particular, the laser projector may comprise at least one LFI (laser feedback interferometry) sensor. Alternatively, for detecting the infrared light reflected by the eye of the user, a discrete external photodetector may also be used, which could, for example, be arranged in the lens, a frame, or the temple of the glasses.

Furthermore, according to an example embodiment of the present invention, it is provided that the wavelength-selective optical element of the optical system is configured, in particular by means of a predistortion of the infrared laser signal, to compensate, in particular precompensate, at least substantially for a distortion of the infrared laser signal that is produced by the replicating optical element (the replication optics). This can advantageously make reliable and/or particularly accurate detection and/or tracking of the pupil position possible. Advantageously, in this case, the reflection image (the retinal speckle pattern) reflected by the retina provides information about the pupil, in particular its position and/or shape and/or size, as precisely as possible. As a result, the infrared component of the laser beam bundle advantageously impinges particularly perpendicularly on the pupil plane, in particular the pupil to be monitored. In this context, a distortion to be compensated, in particular to be precompensated, can also be formed by focusing or defocusing the infrared laser signal. The term “precompensation” is in particular understood to mean a compensation of an optical distortion that is carried out before the optical element producing the optical distortion has even been passed through.

For example, prior to passing through a holographic-optical element integrated in a lens of the data glasses, which element has the task of focusing the visible laser signal in the pupil plane and also has a certain (e.g., partial) focusing effect for the infrared laser signal, or prior to passing through the replicating optical element, which can likewise have a focusing or at least a distorting effect, the infrared laser signal can be defocused by the wavelength-selective optical element in such a way that the holographic-optical element integrated in the lens of the data glasses no longer focuses the infrared light signals exiting the wavelength-selective optical element but are as parallel as possible to one another. The infrared laser signal being “substantially compensated or precompensated” by the wavelength-selective optical element is in particular understood to mean that, after exiting the holographic-optical element integrated in the lens of the data glasses, in particular the last optical element of the optical system, the infrared laser signal has a deviation from parallelity, in particular in comparison to the parallelity of the infrared laser signal upstream of the first optical element of the optical system, for example of the replicating optical element, or after exiting the laser projector, of less than 1°, preferably less than 0.5°, preferably less than 0.2°, and particularly preferably of less than 0.1°. In particular, the compensation, preferably precompensation, is a chromatic compensation. In particular, the compensation/precompensation compensates/precompensates for a distortion produced by an achromatic optical element, such as a segment lens.

Furthermore, according to an example embodiment of the present invention, it is provided that the wavelength-selective optical element is designed as a holographic-optical element (HOE). This can advantageously achieve high versatility and/or good adjustability of the optical function. In addition, a compact design, a passive functionality and/or an inexpensive implementation of the wavelength-selective optical element can advantageously be achieved. In particular, with HOEs, selective refraction of light can be achieved, wherein refractive interaction may be limited to light in certain wavelength ranges.

Furthermore, according to an example embodiment of the present invention, it is provided that the wavelength-selective optical element is arranged in the optical system and in the optical path of the laser beam bundle upstream of the replicating optical element. This can advantageously make precompensation possible. In addition, a simpler design of the wavelength-selective optical element can thereby be achieved.

In addition, according to an example embodiment of the present invention, it is provided that the wavelength-selective optical element of the optical system and the replicating optical element of the optical system are connected to one another in a firmly bonded manner, in particular glued to one another or laminated to one another. This allows a simple and particularly stable assembly of the optical system to be achieved. In addition, a particularly stable alignment of the wavelength-selective optical element relative to the replicating optical element can advantageously be achieved. Preferably, the wavelength-selective optical element of the optical system and the replicating optical element of the optical system are manufactured separately and subsequently fixed to one another. Preferably, when using an adhesive for creating the firmly bonded connection, an adhesive with a refractive index adapted to the refractive index/indices of the optical elements involved is used.

Alternatively, according to an example embodiment of the present invention, it is provided that an optical function of the wavelength-selective optical element and an optical function of the replicating optical element are combined in a common, in particular monolithic, optical element of the optical system. As a result, a simple and in particular stable assembly of the optical system can advantageously be achieved. Advantageously, a number of components can be reduced, which can in particular simplify assembly.

If the common optical element of the optical system is designed as a segment lens made of a photo-thermo-refractive glass (PTR glass), a particularly high resolution (>2500 lines/mm) of the optical functions can advantageously be achieved.

Advantageously, a (master) hologram can be captured by reverse capture with a capture wave adapted to the target wave front. The structure necessary for this capture contains all components in the constructed and adjusted state with an unfunctionalized holographic material at the later target position of the hologram. For capturing, the desired target wave front as well as a wave front corresponding to the laser beam later used in the data glasses is then used to capture the (master) hologram in the reverse direction. Alternative capture processes for the corresponding holograms are of course possible.

In addition, according to an example embodiment of the present invention, it is provided that the eye tracking device, in particular the virtual retinal scan display, preferably the pair of data glasses, is configured at least to detect the pupil position by means of the bright pupil effect. As a result, reliable and precise determination of the position, movement, shape and/or size of the pupil of the eye of the user can advantageously be made possible. The bright pupil effect advantageously produces a strong iris/pupil contrast and thus allows the pupil size, pupil positions, and/or pupil shapes to be detected for all iris pigmentations. The bright pupil effect is in particular brought about by the phenomenon that the retina reflects an increased proportion of incident light when the wavelength of the light is in the (infrared) range of about 850 nm. In particular, due to its surface roughness, the retina of the eye of the user produces the retinal speckle pattern, which can be recorded by the detector and subsequently evaluated, e.g., by a computer unit of the data glasses, when reflecting the collimated infrared laser signal. The terms “provided” and/or “configured” are in particular understood to mean specifically programmed, designed, and/or equipped. An object being provided for a particular function is in particular understood to mean that the object fulfills and/or performs this particular function in at least one application state and/or operating state.

According to an example embodiment of the present invention, it is additionally provided that, in particular at least for detecting a bright pupil signal, the laser projector comprises the integrated LFI sensor at least for sensing a reflection of the infrared laser signal of the laser beam bundle, preferably an infrared laser speckle pattern reflected by the retina of the user eye through the pupil. As a result, a particularly compact design can advantageously be achieved. For example, the LFI sensor may be formed by a silicon photodiode, which may preferably be integrated in a Bragg reflector of the infrared diode laser of the laser projector.

Furthermore, according to an example embodiment of the present invention, it is provided that the wavelength-selective optical element of the optical system is configured, in particular by means of a corresponding (additional) distortion of the infrared laser signal, to compensate, in particular precompensate, at least substantially for a distortion of the infrared laser signal that is produced by a vision defect of a user eye, for example myopia of the user eye or hyperopia of the user eye. As a result, reliable and/or simple detection and/or tracking of a pupil position can advantageously be achieved even in the case of ametropic, e.g., myopic or hyperopic, eyes of a user. In this case, the “distortion” produced by the vision defect may comprise “over-focusing” or “under-focusing.”

Furthermore provided according to an example embodiment of the present invention are data glasses comprising the eye tracking device and/or an eye tracking method for detecting and/or tracking the pupil position, in particular in the data glasses, by means of at least the virtual retinal scan display, in particular by using the eye tracking device, wherein laser beam bundle which comprises at least the visible laser signal, in particular RGB laser signal, and at least the infrared laser signal and which projects at least the (RGB) image to be displayed is emitted in the method, wherein, in the optical system, the (RGB) image to be displayed is reproduced for outputting into a plurality of exit pupils (eyeboxes) of the optical system, said exit pupils being spaced apart from one another at least in the pupil plane of the virtual retinal scan display, and wherein only the infrared laser signal of the laser beam bundle is manipulated in at least the wavelength-selective optical element of the optical system, whereas the visible laser signal, in particular the RGB laser signal, of the laser beam bundle simultaneously passes, at least substantially unchanged, through the wavelength-selective optical element of the optical system. As a result, an eye-tracking function can advantageously be integrated into the laser projector of the virtual retinal scan display. Advantageously, a visible image can be generated and pupil tracking can be carried out simultaneously by means of a single laser projector. This can advantageously reduce costs and required installation space.

If the wavelength-selective optical element of the optical system compensates, in particular precompensates, at least substantially for at least one distortion of the infrared laser signal that is produced in the reproduction process of the (RGB) image to be displayed into a plurality of exit pupils, reliable and/or particularly accurate detection and/or tracking of the pupil position can also advantageously be made possible.

The eye tracking device according to the present invention, the data glasses according to the present invention, and the eye tracking method according to the present invention are not to be limited to the applications and embodiments described above. In particular, for fulfilling a functionality described here, the eye tracking device according to the present invention, the data glasses according to the present invention and the eye tracking method according to the present invention can have a number of individual elements, components and units, as well as method steps, that deviates from the number mentioned here. In addition, for the value ranges specified in this disclosure, values within the mentioned limits are also to be considered disclosed and usable as desired.

### BRIEF DESCRIPTION OF THE DRAWINGS

Further advantages result from the following description of the figures. An embodiment of the present invention is illustrated in the figures. The figures, the description, and all other portions of the disclosure herein contain numerous features in combination. A person skilled in the art will expediently also consider the features individually and combine them to form meaningful further combinations.

FIG. 1 shows a schematic illustration of a pair of data glasses comprising an eye tracking device, according to an example embodiment of the present invention.

FIG. 2 shows a schematic illustration of a laser projector and an optical system of the eye tracking device, according to an example embodiment of the present invention.

FIG. 3 shows an exemplary infrared laser signal scattered back by a user eye and having an infrared laser speckle pattern, according to the present invention.

FIG. 4A shows schematically, optical paths of the infrared light signal in a healthy user eye.

FIG. 4B shows schematically, optical paths of the infrared light signal in a myopic user eye.

FIG. 4C shows schematically, optical paths of the infrared light signal in a hyperopic user eye.

FIG. 5 shows a schematic flowchart of an eye tracking method, according to an example embodiment of the present invention.

### DETAILED DESCRIPTION OF EXAMPLE EMBODIMENTS

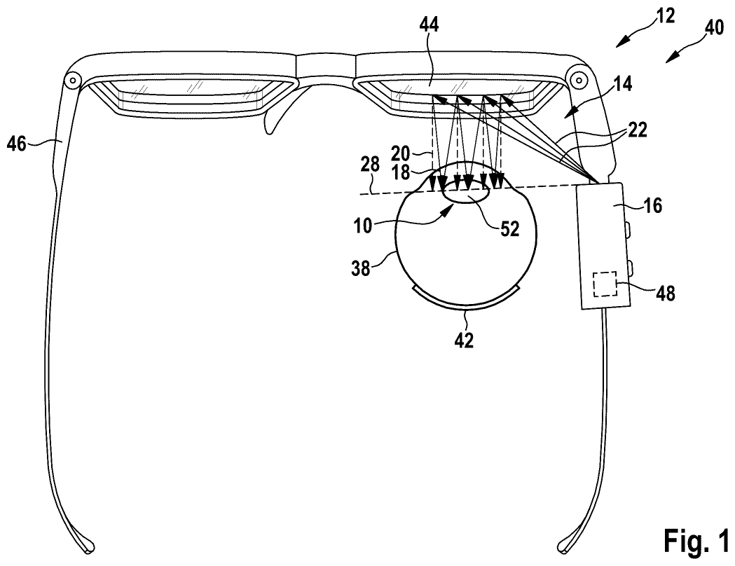

FIG. 1 is a schematic illustration of a pair of data glasses 12. The data glasses 12 comprise an eye tracking device 40. The eye tracking device 40 comprises a virtual retinal scan display 14. The data glasses 12 comprise a frame 46. The data glasses 12 comprise lenses 44. The data glasses 12 are configured to detect and/or track a pupil position 10 of a pupil 52 of a user eye 38 by means of the eye tracking device 40. The data glasses 12 are configured to project an (RGB) image onto a retina 42 of the user eye 38. The eye tracking device 40 comprises a laser projector 16. The laser projector 16 is designed as a scanned laser projector. The laser projector 16 is provided to generate and output a scanned laser beam bundle 22. The scanned laser beam bundle 22 comprises a visible laser signal 18. The visible laser signal 18 is formed as an RGB laser signal. The scanned laser beam bundle 22 comprises an infrared laser signal 20. The visible laser signal 18 of the scanned laser beam bundle 22 generates an image display of the data glasses 12. The infrared laser signal 20 of the scanned laser beam bundle 22 is used to detect and/or track the pupil position 10 of the user eye 38. The scanned laser beam bundle 22 can be provided for ascertaining a pupil position 10, pupil movement, pupil shape, and/or pupil size, for example via the bright pupil effect. The eye tracking device 40 is configured at least to detect the pupil position 10 by means of the bright pupil effect. The laser projector 16 is at least partially integrated into the frame 46. The data glasses 12 comprise a computing unit 48. The computing unit 48 is provided for executing an operating program of the data glasses 12, via which at least a majority of the main functions of the data glasses 12 are preferably executable. The computing unit 48 is provided for carrying out an eye tracking method for detecting and/or tracking the pupil position 10 by means of the data glasses 12 comprising the virtual retinal scan display 14.

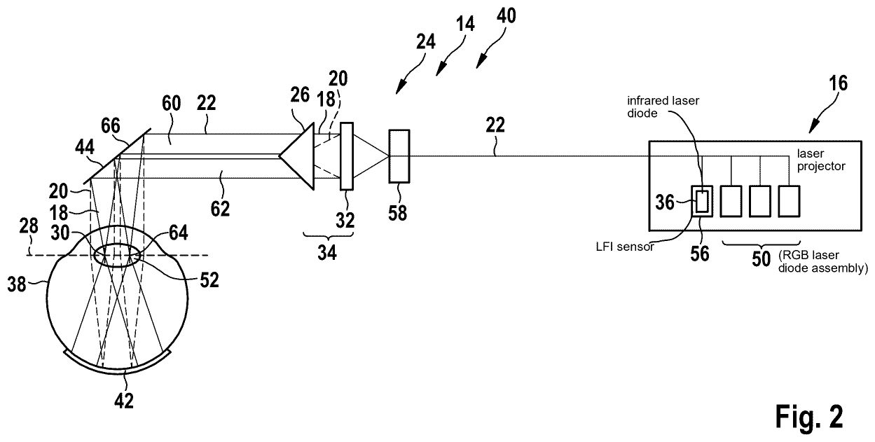

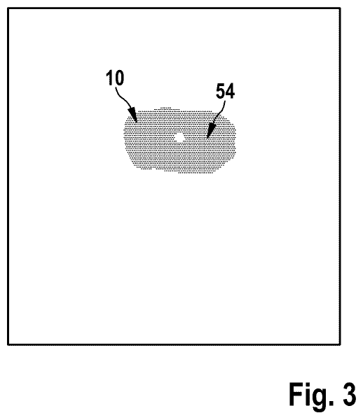

FIG. 2 shows a schematic illustration of the laser projector 16 and an optical system 24 of the eye tracking device 40. The laser projector 16 comprises an RGB laser diode assembly 50. The RGB laser diode assembly 50 is provided for emitting the visible laser signal 18. The laser projector 16 comprises an infrared laser diode 56. The infrared laser diode 56 is provided for emitting the infrared laser signal 20. Within the laser projector 16, the infrared laser signal 20 and the visible laser signal 18 are combined to form the laser beam bundle 22. The laser projector 16 comprises a laser feedback interferometry (LFI) sensor 36. The LFI sensor 36 is integrated in the infrared laser diode 56. The infrared laser diode 56, and thus also the LFI sensor 36, is at a first position (i.e., at a position closest to a beam output of the laser projector 16) of all laser diodes 50, 56 of the laser projector 16. The LFI sensor 36 is provided for detecting a bright pupil signal. The LFI sensor 36 is provided for sensing a reflection of the infrared laser signal 20 of the laser beam bundle 22 that is reflected by the user eye 38, in particular the retina 42 of the user eye 38, through the pupil 52. The LFI sensor 36 is provided for sensing an infrared laser speckle pattern 54 reflected by the retina 42 through the pupil 52 (cf. FIG. 3).

The eye tracking device 40 comprises the optical system 24. The optical system 24 comprises a replicating optical element 26. The replicating optical element 26 is configured to reproduce the (RGB) image to be displayed, for outputting into a plurality of exit pupils 30, 64 of the optical system 24. The replicating optical element 26 is designed as a segment lens. However, alternative designs of the replicating optical element 26 are likewise possible. The plurality of exit pupils 30, 64, each comprising the (RGB) image to be displayed and a portion of the infrared laser signal 20, are arranged spaced apart from one another in a pupil plane 28 of the virtual retinal scan display 14 (cf. also FIG. 1). In the embodiment example shown in FIG. 2, the replicating optical element 26 generates two beam replicas 60, 62, each entering a different exit pupil 30, 64 in the pupil plane 28.

The optical system 24 comprises a wavelength-selective optical element 32. The wavelength-selective optical element 32 is arranged in the optical system 24 and in the optical path of the laser beam bundle 22 upstream of the replicating optical element 26. The wavelength-selective optical element 32 is arranged in the optical system 24 and in the optical path of the laser beam bundle 22 downstream of a micromirror 58 producing the scanning movement of the laser beam bundle 22. The micromirror 58 scans the laser beam bundle 22 via the wavelength-selective optical element 32. The use of conventional scanning units and alternative to the micromirror 58 is of course likewise possible. The wavelength-selective optical element 32 is formed as a holographic-optical element (HOE). However, alternative designs of the wavelength-selective optical element 32 are likewise possible. The wavelength-selective optical element 32 is configured to manipulate only the infrared laser signal 20 of the laser beam bundle 22 and to allow the visible laser signal 18 of the laser beam bundle 22 to pass through at least substantially unchanged. The wavelength-selective optical element 32 is configured to compensate at least substantially for a distortion of the infrared laser signal 20 that is produced by the replicating optical element 26. The wavelength-selective optical element 32 is configured, by means of a predistortion of the infrared laser signal 20, to precompensate at least substantially for a (known) distortion of the infrared laser signal 20 that is only subsequently produced by the replicating optical element 26 arranged downstream of the wavelength-selective optical element 32.

The wavelength-selective optical element 32 and the replicating optical element 26 are designed to be combined in a single component. The combination of the wavelength-selective optical element 32 and the replicating optical element 26 into the single component may be achieved in two different ways. The wavelength-selective optical element 32 and the replicating optical element 26 may be connected to one another in a firmly bonded manner, e.g., by gluing them to one another or by laminating them to one another. Alternatively, a wavelength-selective optical function of the wavelength-selective optical element 32 and a replicating optical function of the replicating optical element 26 may be combined into an integral, preferably monolithic, segment lens made of a photo-thermo-refractive glass (PTR glass).

The optical system 24 comprises a deflection element 66. The deflection element 66 is designed as an HOE. The deflection element 66 is integrated in one of the lenses 44 of the glasses. The deflection element 66 is configured to deflect the beam replicas 60, 62 toward the user eye 38. The deflection element 66 is configured to focus the visible light signal 18 of the beam replicas 60, 62 into the exit pupils 30, 64. The deflection element 66 is configured to manipulate the predistorted/precompensated infrared light signal 20 of the beam replicas 60, 62 in such a way that it impinges perpendicularly on the user eye 38 and/or the pupil plane 28. The deflection element 66 may be provided only for deflecting the predistorted/precompensated infrared light signal 20 or may generate a distortion that is likewise precompensated by the wavelength-selective optical element 32.

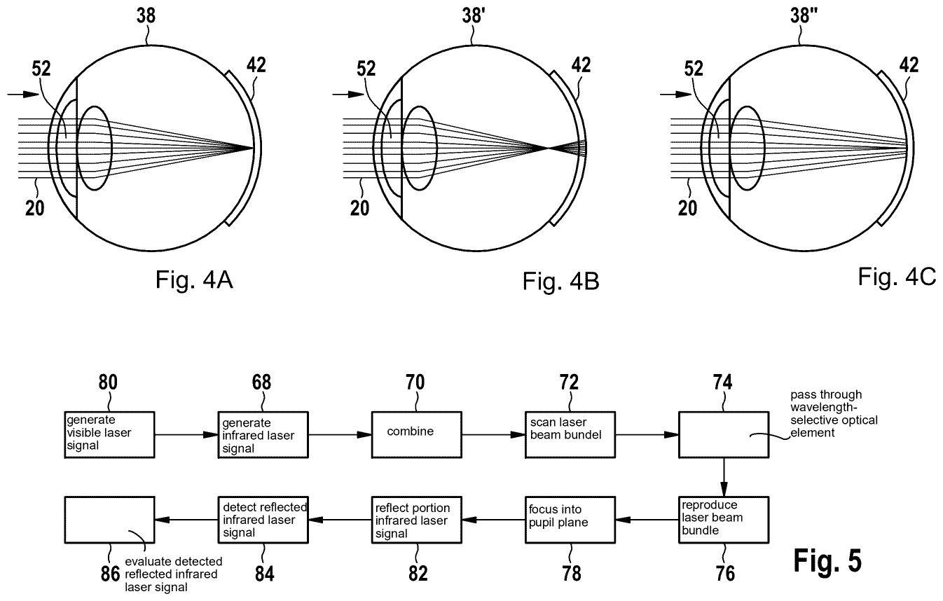

FIGS. 4A to 4C schematically show the optical paths in a healthy user eye 38 (FIG. 4A), in a myopic user eye 38′ (FIG. 4B), and in a hyperopic user eye 38″ (FIG. 4° C.). The wavelength-selective optical element 32 of the optical system 24 can be selected to be configured, by means of an (additional) distortion of the infrared laser signal 20, to precompensate at least substantially for an undesirable vision defect distortion of the infrared laser signal 20 that is produced by a vision defect of the user eye 38, 38′, 38″, for example myopia of the user eye 38′ or hyperopia of the user eye 38″. In this case, the wavelength-selective optical element 32 is provided to precompensate at least substantially for the vision defect distortion of the infrared laser signal 20 that is produced in the user eye 38, 38′, 38″ by the particular vision defect of the user eye 38, 38′, 38″.

FIG. 5 shows a schematic flowchart of an eye tracking method for detecting and/or tracking the pupil position 10 of the user eye 38 by means of the eye tracking device 40 of the data glasses 12. In at least one method step 80, the visible laser signal 18 is generated by the laser projector 16. In at least one further method step 68, the infrared laser signal 20 is generated by the laser projector 16. In at least one further method step 70, the visible laser signal 18 and the infrared laser signal 20 are combined to form the laser beam bundle 22. In at least one further method step 72, the laser beam bundle 22 is scanned via the wavelength-selective optical element 32. In at least one further method step 74, the laser beam bundle 22 passes through the wavelength-selective optical element 32. When the wavelength-selective optical element 32 is passed through, only the infrared laser signal 20 of the laser beam bundle 22 is manipulated, whereas the visible laser signal 18 of the laser beam bundle 22 simultaneously passes, at least substantially unchanged, through the wavelength-selective optical element 32. In method step 74, at least one known distortion of the infrared laser signal 20 that is produced only later in multiple exit pupils 30, 64 in the reproduction process of the (RGB) image to be displayed is precompensated at least substantially by the wavelength-selective optical element 32 by means of a predistortion of the infrared laser signal 20. In at least one further method step 76, the laser beam bundle 22 is reproduced with the unchanged visible laser signal 18 and with the predistorted infrared laser signal 20 by the replicating optical element 26 to form the plurality of beam replicas 60, 62. In at least one further method step 78, the beam replicas 60, 62 are each deflected toward the user eye 38 by the deflection element 66 integrated in one of the lenses 44 of the glasses. In method step 78, the respective visible laser signals 18 of the beam replicas 60, 62 are focused by the deflection element 66 into the pupil plane 28. In method step 78, the respective predistorted/precompensated infrared laser signals 20 of the beam replicas 60, 62 are manipulated by the deflection element 66 in such a way that their individual beams are parallel and impinge perpendicularly on the user eye 38 and/or on the pupil plane 28. In at least one further method step 82, a portion of the infrared laser signal 20 is reflected by the retina 42 and passes through the optical system 24 in the reverse direction toward the LFI sensor 36. In at least one further method step 84, the LFI sensor 36 detects the reflected infrared laser signal 20. In at least one further method step 86, the signal detected by the LFI sensor 36 is evaluated by the computing unit 48 at least for determining the pupil position 10.

1-13. (canceled)

14. An eye tracking device for detecting and/or tracking a pupil position in a pair of data glasses. the eye tracking device comprising:
at least one virtual retinal scan display having at least one laser projector configured at least to emit a laser beam bundle which includes at least one visible laser signal, and at least one infrared laser signal, and which projects at least one image to be displayed, and having at least one optical system including at least one replicating optical element configured at least to reproduce the image to be displayed, for outputting into a plurality of exit pupils of the optical system, the exit pupils being spaced apart from one another at least in a pupil plane of the virtual retinal scan display, wherein the optical system includes a wavelength-selective optical element configured to manipulate only the infrared laser signal of the laser beam bundle and to allow the visible laser signal of the laser beam bundle to pass through at least substantially unchanged.

15. The eye tracking device according to claim 14, wherein the at least one visible laser signal is an RGB laser signal, and the at least one image is an RGB image.

16. The eye tracking device according to claim 14, wherein the wavelength-selective optical element of the optical system is configured, using a predistortion of the infrared laser signal, to compensate at least substantially for a distortion of the infrared laser signal that is produced by the replicating optical element.

17. The eye tracking device according to claim 14, wherein the wavelength-selective optical element is a holographic-optical element.

18. The eye tracking device according to one of claims 14, wherein the wavelength-selective optical element is arranged in the optical system and in an optical path of the laser beam bundle upstream of the replicating optical element.

19. The eye tracking device according to claim 14, wherein the wavelength-selective optical element of the optical system and the replicating optical element of the optical system are connected to one another in a firmly bonded manner.

20. The eye tracking device according to claim 19, wherein the wavelength-selective element and the replicating optical element are glued to one another or laminated to one another.

21. The eye tracking device according to claim 14, wherein an optical function of the wavelength-selective optical element and an optical function of the replicating optical element are combined in a common optical element of the optical system.

22. The eye tracking device according to claim 21, wherein the common optical element of the optical system is formed as a segment lens made of a photo-thermo-refractive glass.

23. The eye tracking device according to claim 14, wherein the eye tracking device is configured at least to detect the pupil position using a bright pupil effect.

24. The eye tracking device according to claim 23, wherein at least for detecting a bright pupil signal, the laser projector includes an integrated laser feedback interferometry sensor at least for sensing a reflection of the infrared laser signal of the laser beam bundle.

25. The eye tracking device according to claim 24, wherein at least for detecting a bright pupil signal, the laser projection includes an integrated laser feedback interferometry sensor at least for sensing an infrared laser speckle pattern reflected by a retina of a user eye.

26. The eye tracking device according to claim 14, wherein the wavelength-selective optical element of the optical system is configured, using a distortion of the infrared laser signal, to compensate at least substantially for a distortion of the infrared laser signal that is produced by a vision defect of a user eye.

27. The eye tracking device according to claim 26, wherein the vision defect includes myopia of the user eye or hyperopia of the user eye.

28. Data glasses, comprising:
an eye tracking device including:
at least one virtual retinal scan display having at least one laser projector configured at least to emit a laser beam bundle which includes at least one visible laser signal, and at least one infrared laser signal, and which projects at least one image to be displayed, and having at least one optical system including at least one replicating optical element configured at least to reproduce the image to be displayed, for outputting into a plurality of exit pupils of the optical system, the exit pupils being spaced apart from one another at least in a pupil plane of the virtual retinal scan display, wherein the optical system includes a wavelength-selective optical element configured to manipulate only the infrared laser signal of the laser beam bundle and to allow the visible laser signal of the laser beam bundle to pass through at least substantially unchanged.

29. An eye tracking method for detecting and/or tracking a pupil position in a pair of data glasses, using at least one virtual retinal scan display, the method comprising the following steps:
emitting at least one laser beam bundle including at least one visible laser signal and at least one infrared laser signal which projects at least one image to be displayed;
in an optical system, reproducing the image to be displayed for outputting into a plurality of exit pupils of the optical system, the exit pupils being spaced apart from one another at least in a pupil plane of the virtual retinal scan display;
wherein only the infrared laser signal of the laser beam bundle is manipulated in at least a wavelength-selective optical element of the optical system, whereas the visible laser signal of the laser beam bundle simultaneously passes, at least substantially unchanged, through the wavelength-selective optical element of the optical system.

30. The eye tracking method according to claim 29, wherein at least one distortion of the infrared laser signal that is produced in multiple exit pupils in a reproduction process of the image to be displayed is compensated at least substantially by the wavelength-selective optical element of the optical system.
